(19) United States
(12) Patent Application Publication
(10) Pub. No.: US 2014/0035352 A1
(43) Pub. Date: Feb. 6, 2014

(54) QUICK RELEASE SKATEBOARD WHEEL

(71) Applicants: Jonathan Michael Waller, New York, NY (US); Joseph Palermo, Hillsdale, NY (US)

(72) Inventors: Jonathan Michael Waller, New York, NY (US); Joseph Palermo, Hillsdale, NY (US)

(21) Appl. No.: 13/565,196

(22) Filed: Aug. 2, 2012

(51) Int. Cl. B60B 37/10; B23P 6/00

(52) U.S. Cl. 301/121; 29/402.03

(57) ABSTRACT

The apparatus and system described is directed to securing a wheel to an axel without the use of separate tools or devices. The present invention allows for securing the wheel to the axel through the use of a specialized locking mechanism and wheel bearing. When mated, these two elements allow for a wheel that does not require user access to a central hub in order to replace the wheel. Thus, the apparatus and device provide for wheel geometries that take advantage of lack of a hub. For example, the present invention allows for wheel designs that enable a wider range of performance characteristics than offered by prior art devices.

### BACKGROUND OF THE INVENTION

1. Field of the Invention

The present invention relates to apparatus and method for changing or replacing the wheels of a personal transport device.

2. Discussion of the Related Art

Skateboards wheels and the wheels of other similar transport devices are known in the art. For example, skateboard wheels generally are known to be of solid construction and do not incorporate inflatable tires, rims, or other accents that have a use in general wheel construction. It is known in the art to fabricate skateboard wheels from different types of material. For example, semi-hard rubber materials provide a comfortable, shock-absorbing wheel structure and a relatively high coefficient of friction in contact with the ground.

A problem unsolved in the prior art is that the wheels of skateboards and other personal transport devices require several discrete tools in order to change wheels. As such, whenever a wheel change is desired, a time consuming and labor intensive process is undertaken. Additionally, because of the design of prior art wheels (a hollow axel) different wheel types are not permissible. For example, wheels of varying geometry are impossible since each compatible wheel requires access to the wheel hub from both directions. What is needed is a system that allows for the easy replacement or exchanging of wheels. Additionally, what is needed is a wheel system that allows for wheels that have a greater range of geometries and performance characteristics.

Therefore, what is needed is a system for skateboards and other wheeled recreational products which corrects these deficiencies and provides for an easily replaceable wheel, in combination with a durable, long lasting and stable sporting device that has improved performance characteristics across a spectrum of road surfaces.

### SUMMARY OF THE INVENTION

The present invention is directed to wheel apparatus for a skateboard that allows the quick removal and replacement of wheels without the need for tools. Furthermore, the present invention allows for an expanded selection of geometrically diverse wheels with superior characteristics for a proposed activity. More specifically, the present invention is directed to an interchangeable wheel apparatus that allows the operator of a skateboard, without tools, to swap wheel types.

In an illustrative embodiment of the present invention, the system and apparatus encompasses a truck mechanism that is attached to a skateboard or other personal transport device (i.e. roller skates, blades, or scooter). The truck mechanism allows a bearing to be cast into each wheel. Each wheel cast onto the truck is equipped with a specialized bearing that eliminates the need to use washers and bolts to affix the wheel to the axel of the skateboard, or similar personal transport device.

The truck mechanism includes locking mechanism which, in one position, enables the bearing to be secured to the truck and is prevented from slipping off the wheel axel. In a second mode, the locking mechanism is disengaged. This allows the wheel and bearing to be removed from the truck and replacement wheel to be secured. In one embodiment of the invention, the bearing is fabricated with an internal and external notches designed to act as movement arrestors. The internal notch receives from the locking mechanism a tab that secures it to the truck. Likewise, the wheel also provides tabbed elements across the entire circumference of the rolling bearing, thereby preventing movement independent of the wheel. The result is that the wheel itself can be shaped in any three dimensional form that is envisioned. Since the present invention eliminates the necessity for a bolt and nut to secure the wheel, the wheel is configured without the central hub accessible from both ends. Thus, a greater range of geometric configurations is possible.

The present invention is also directed to a method of affixing and removing the roller bearing and wheels without the necessity of tools. In an illustrative embodiment of the present invention, the roller bearing and wheel are secured to the truck axel through the use of a locking lever that is disengaged. Once the wheel is secured on the axel, the locking lever is engaged and the wheel and rolling bearing are prevented from sliding off the axel.

It is further envisioned that in one arrangement, the wheel is separable from the bearing without the necessity of tools. The bearing and wheel are provided as two distinct elements. As an illustrative example, the present invention provides for a flexible wheel surface equipped with arresters that prevent the wheel from moving independent of the roller bearing. Once engaged used on a road surface, the wheel will transfer the transfer the motion to the entire device.

In another aspect of the present invention, the wheel surface is adapted to a particular activity such as street racing, or acrobatic tricks. The present invention provide for an outer peripheral edge of the wheel which allows greater lateral movement control when combined with low coefficient of friction devices.

### BRIEF DESCRIPTION OF THE DRAWINGS

The foregoing and other features of the present invention will be more readily apparent from the following detailed description and drawings of illustrative embodiments of the invention in which list the drawings and their captions. For example:

FIG. 1 is an illustrative side view of an embodiment of the invention;

### DETAILED DESCRIPTION OF THE INVENTION

By way of overview and introduction, the present invention concerns a method and apparatus for replacing and securing wheels onto a personal transport device such as a skateboard or scooter. The apparatus and system is directed to securing a wheel to an axel without the use of separate tools or devices. The present invention allows for securing the wheel to the axel through the use of a specialized locking mechanism and wheel bearing. When mated, these two elements allow for a wheel that does not require user access to a central hub in order to replace the wheel. Thus, the apparatus and device described provide for wheel geometries that take advantage of lack of a hub. For example, the present invention allows for wheel designs that enable a wider range of performance characteristics than offered by prior art devices.

It should be noted that the wheels and associated mechanism provided in the present illustrations and embodiments are equally applicable not only to skateboards, but also to scooters, roller skates and other personal transport devices. For ease of illustration and description, the elements of the system and apparatus are described in relation to a skateboard vehicle. However, those skilled in the art will appreciate that the devices described are in no way limited to the described in the illustrated elements.

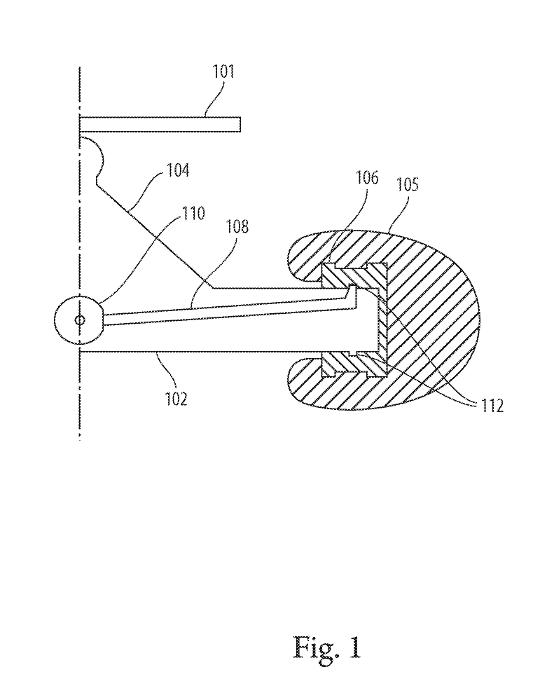

As seen in FIG. 1, the present invention provides for a skateboard with a removable wheel and bearing. As seen, the platform 101 of the skateboard is configured with a truck 104. The truck 104 provides support for an axel 102 and allows different platforms 101 to be secured, for the purposes of customization. The axel 102 in the illustrated embodiment is a part of the skateboard truck 104. However, in alternative embodiments, the axel 102 is formed of a separate piece or construction and is mated or coupled to the truck. Again, those skilled in the art will appreciate that the truck 104 components are widely commercially available and customizable.

The axel 102 and truck 104 as depicted in the illustrated embodiment are of standard commercial dimensions for the particular device they are incorporated. As such, wider platform boards such as long boards will have larger dimensions than shorter “partk” boards.

In the depicted embodiment, the axel 102 is formed as a hollow member that extends from the truck 104 and is inserted into the roller bearing 106. The axel 102 is formed of a workable material such as metal, synthetic and/or carbon fibers, high-impact plastics or other material suitable for the performance demands of the axel 102. In the illustrated arrangement, the axel 102 is co-extensive and formed as a single construction with the truck 104. However, in an alternative embodiment, the axel is a removable element that is attached to the truck 104 by way of threaded receiving devices, specialized fasteners or other designs and configurations suitable for stably and securely joining the axel 102 and the truck 104.

A roller bearing 106 is configured to fit over the end of the axel 102 not connected to or co-extensive with, the truck 104. The roller bearing 106 is formed as a cylindrical central wheel hub having an exterior surface and an interior surface. In the illustrated depictions, the roller bearing 106 is designed to be coupled to the axel 102, but not secured to the axel 102. The roller bearing 106 has a closed end and an open end. The dimensions of the roller bearing 106 are in part, configured so that the closed end portion acts as a positioning element which prevents the axel 102 from advancing further than a predetermined length into the roller bearing 106.

The roller bearing 106 is equipped with a restraining elements 112 that are co-extensive with the interior surface of the roller bearing 106. In the illustrated depiction, the restraining elements 112 are configured as a recessed or depressed portion of the inner surface. In the alternative, the restraining elements 112 are formed of an extruded portion or tab. Those skilled in the art will appreciate the various designs that are capable achieving the desired design goals. Furthermore, those skilled in the art will appreciate that the restraining elements 112 if not co-extensive with the inner surface of the roller bearing 106, are formed of any suitable material that is capable of achieving the function of the desired element.

As illustrated in FIG. 1, the apparatus also includes a locking lever 108. The locking lever 108 is equipped with a coupling end and a locking end. In operation, the coupling end of the locking lever 108 is equipped with a protrusion that is engaged with the restraining element 112. Upon engagement, the rolling bearing is prevented from being disengaged from the axel 102. The restraining element 112 spans the circumference of the interior surface of the roller bearing 106; as such the locking lever 108 secures the roller bearing, 106 even during active rotations. Furthermore, because of the arrangement of the protrusion and the restraining element 112, the wheel is able to freely rotate about the axel 102, without interference from the locking lever 108.

The locking end of the locking lever 108 is connected to a locking mechanism 110. The locking mechanism 110 is configured to be co-extensive with the truck 104. Furthermore, the locking mechanism is configured to be accessible to a user. In the illustrated embodiment, the locking mechanism is operated manually and does not require a tool.

In one arrangement of elements, the locking mechanism 110 is a rotating mechanism having an open and closed position. In rotating the mechanism to the locked position, the locking lever 108 is inserted into the depression formed by the restraining element 112. Alternatively, when the lock selector is rotated into the unlocked position, the locking lever 108 is withdrawn from the restraining element 112. In the unlocked position, the wheel and co-extensive roller bearing 106 can be removed from the axel 102 and exchanged for a replacement ground contacting elements and roller bearing pair. Those skilled in the art will appreciate that the locking mechanism 110 is not limited to a rotating mechanism. For example, a sliding tab, or spring activated lever are suitable alternative mechanical arrangements for coupling the locking lever 108 and the locking mechanism 110 such that successful securing of the rolling bearing 106 is achieved.

In a still further arrangement, the locking lever 108 is configured as two separate elements connected by a control cable, such as a throttle cable with a plunger (not shown). In this arrangement, the activation elements are positioned on the truck 104 or platform 101. The cable element is positioned within the axel 102, and the mechanism of action (i.e. plunger) is permanently affixed to the axel 102 at a position that allows selective engagement with the restraining element 108.

In operation, the locking lever 108, when in the unlocked, or unselected position, allows the rolling bearing to be removed from the axel. In one arrangement, the roller bearing 106 is modifiable by configuring it with different exterior ground contacting elements 105. As seen in FIG. 1, the ground contacting elements 105 is formed to envelope a portion of the roller bearing 106 such that only the open end is accessible. Those skilled in the art will appreciate that the configuration of the exterior wheel cover can take any shape so long as the access to the open end of the roller bearing 106 is maintained. For example, as shown in the illustrated arrangement, the ground contacting element 105 is configured with an elongated or oval shape. This extended shape provides enhanced functionality of the transport device and allows for an extended range of maneuvers.

The ground contacting element 105 is constructed out of standard materials that are suitable for the functions of a skateboard. The ground contacting element 105 in a particular embodiment of the present invention is formed of urethane or another material having a given coefficient of friction suitable for the proposed activity.

In an alternative embodiment, the ground contacting element 105 is co-extensive and formed of a single construction with the roller bearing 106. In this configuration the entire structure is removable, but not separately customizable.

The present invention is also directed to a method of securing removable wheels to an axel that is equipped with a tool-less wheel release mechanism. The method includes a step for disengaging the locking mechanism, removing the roller bearing, inserting a replacement or alternative roller bearing and wheel cover on the axel; and re-engaging the wheel locking mechanism. Those skilled in the art will appreciate that the possible steps of the describe method are not limited to the exemplary ones provided and can incorporate additional steps such as removing the wheel covering from the roller bearing prior or after removal of the roller bearing from the axel.

It should be understood that various combinations, alternatives and modifications of the present invention could be devised by those skilled in the art. The present invention is intended to embrace all such alternatives, modifications and variances that fall within the scope of the appended claims.

While the invention has been particularly shown and described with reference to a preferred embodiment thereof, it will be understood by those skilled in the art that various changes in form and details may be made therein without departing from the spirit and scope of the invention.

What is claimed is:

1. An apparatus for securing a wheel to an axel, said apparatus comprising:
a cylindrical central wheel hub having an exterior surface and an interior surface and a closed end and an open end, the interior surface accessible from the open end and the interior surface configured with a restraining element positioned around the circumference of the interior surface,
a securing element having a coupling end and a selector end, where the coupling end is configured to be selectively engaged to the restraining element, and the selector end is connected to a selector mechanism configured to control the selective engagement of the coupling end with the restraining element.

2. The apparatus for securing a wheel to an axel of claim 1, wherein the restraining element is a groove formed within the interior surface of the central wheel hub.

3. The apparatus for securing a wheel to an axel of claim 1, wherein the restraining element is a flange.

4. The apparatus for securing a wheel to an axel of claim 1, wherein the selector mechanism and the selector end are secured to the axel.

5. The apparatus for securing a wheel to an axel of claim 1, wherein the exterior surface of the central wheel hub is configured with a wheel restricting element positioned around the entire circumference of the exterior surface.

6. A method of changing the performance characteristics of a ground contact surface of a personal transport device having a wheel selectively coupled to an axel, with a wheel surface covering comprising the steps of:
selecting a wheel covering having desired performance characteristic that differs from the performance characteristic of the primary wheel of the personal transport device;
securing the wheel surface covering having different performance characteristics that the wheel to the surface of the wheel.
